(19) United States
(12) Patent Application Publication
(10) Pub. No.: US 2023/0302318 A1
(43) Pub. Date: Sep. 28, 2023

(54) SYSTEMS AND METHODS FOR SUPERVISORY FOR VALVE

(71) Applicant: Tyco Fire Products LP, Lansdale, PA (US)

(72) Inventors: Gijsbert van Rooijen, Enschede (NL); Joshua Motha, Tiverton, RI (US)

(73) Assignee: Tyco Fire Products LP, Lansdale, PA (US)

(21) Appl. No.: 18/011,395

(22) PCT Filed: Aug. 25, 2021
(86) PCT No.: PCT/IB2021/057796

§ 371 Date: Dec. 19, 2022

Related U.S. Application Data
(60) Provisional application No. 63/074,551, filed on Sep. 4, 2020.

(51) Int. Cl. A62C 37/46; F16K 37/00; F16K 31/06; A62C 37/50

(52) U.S. Cl. CPC A62C 37/46; F16K 37/0033; F16K 31/0644; A62C 37/50

(57) ABSTRACT

A valve assembly includes a valve and a valve sensor. The valve includes a solenoid including a core and a coil, and a valve body having a closed state in which fluid is prevented from flowing through the valve body and an open state in which fluid flows through the valve body. The valve sensor detects at least one of the valve body and the coil and causes an alarm to be triggered responsive to not detecting the at least one of the valve body and the coil in a respective target position of the at least one of the valve body and the coil.

### CROSS-REFERENCE TO RELATED APPLICATIONS

The present application claims the benefit of and priority to U.S. Provisional Application No. 63/074,551, filed Sep. 4, 2020, the disclosure of which is incorporated herein by reference in its entirety.

### BACKGROUND

Sprinkler systems can be used to address fire conditions by outputting fluids responsive to detecting the fire condition. A valve, such a solenoid valve, can be used to control the flow of fluid through the system, such as from a fluid supply to one or more sprinklers.

### SUMMARY

At least one aspect relates to a valve assembly. The valve assembly includes a valve and a valve sensor. The valve includes a solenoid including a core and a coil, and a valve body having a closed state in which fluid is prevented from flowing through the valve body and an open state in which fluid flows through the valve body. The valve sensor detects at least one of the valve body and the coil and causes an alarm to be triggered responsive to not detecting the at least one of the valve body and the coil in a respective target position of the at least one of the valve body and the coil.

At least one aspect relates to a sprinkler system. The sprinkler system includes one or more pipes, at least one fluid distribution device, a solenoid valve, and a valve sensor. The one or more pipes receive fluid from a fluid supply. The at least one fluid distribution device is coupled with the one or more pipes. The solenoid valve is coupled with the one or more pipes between the fluid supply and the at least one fluid distribution device. The solenoid valve selectively allows fluid to flow from the fluid supply to the at least one fluid distribution device. The valve sensor triggers an alarm responsive to detecting that the solenoid valve is not in an operational state.

At least one aspect relates to a valve sensor assembly. The valve sensor assembly includes a bracket, a fastener, and a sensor. The bracket extends from a first end that connects with a solenoid valve to a second end. The fastener secures the first end of the bracket with the solenoid valve. The sensor is coupled with the second end of the bracket and indicates an alarm condition responsive to detecting that the solenoid valve is not in an operational state.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a sprinkler system.

FIG. 2 is a perspective view of an example of a valve of a sprinkler system in an assembled state.

FIG. 3 is a perspective view of an example of a valve of a sprinkler system in a disassembled state.

### DETAILED DESCRIPTION

Following below are more detailed descriptions of various concepts related to, and implementations of systems and methods of a supervisory for a valve. Sprinkler systems can be used in various implementations, including with solenoid valves to control the flow of fluid through the sprinkler systems. The various concepts introduced above and discussed in greater detail below can be implemented in any of numerous ways.

Sprinkler systems can use electrically controlled valves, such as solenoid valves, to control fluid flow from a fluid supply to one or more fluid distribution devices, such as sprinklers or nozzles. During processes such as servicing the valve, one or more components of the valve may be disassembled. For example, a coil of the solenoid may be removed. The coil can be electrically connected with a remote device that provides an electrical current to the coil, such that the electrical connection between the remote device and the coil can be monitored as an indicator of operation of the solenoid. However, if the coil is not replaced into position (e.g., reconnected in a proper position on a core of the solenoid), the valve will not operate even if the electrical connection is present between the remote device and the coil.

Systems and methods in accordance with the present disclosure can use a sensor that monitors the coil of the solenoid to indicate whether the coil is properly positioned so that the valve can be operated. For example, a fastener can be attached with the coil and the core so that an alarm connected with the sensor outputs an indication of an alarm condition unless the valve is reassembled with the coil positioned around the core. This can prevent situations in which the valve is left in a non-operational state even if the electrical connection between the solenoid and the remote device is present.

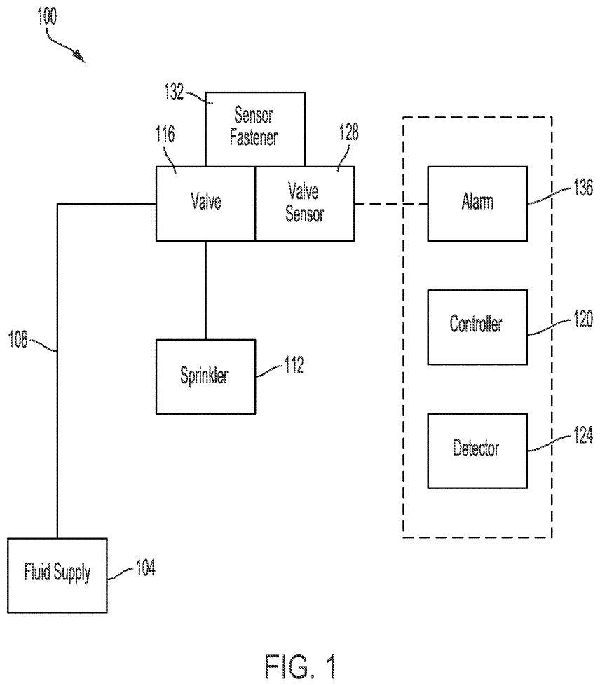

FIG. 1 depicts an example of a sprinkler system 100. The sprinkler system 100 can include a fluid supply 104. The fluid supply 104 can store fluids to be used to address a fire condition, which can include at least one of water and one or more fire suppression agents.

The sprinkler system 100 can include one or more pipes 108. The pipes 108 can be connected with the fluid supply 104 and extend from the fluid supply 104. The pipes 108 can extend through a structure, such as a building. Fluid from the fluid supply 104 can be present in the pipes 108 and flow through the pipes 108. The pipes 108 can include any of a variety of conduits that can be used to flow fluid, including but not limited to piping, tubing, metal pipes, rigid pipes, or polymeric (e.g., chlorinated polyvinyl chloride (CPVC)) pipes.

The sprinkler system 100 can include at least one fluid distribution device 112. The fluid distribution device 112 can include at least one of a sprinkler and a nozzle. The fluid distribution device 112 can be an open sprinkler or nozzle (e.g., a device that has an open flow path from an inlet to an outlet when the device is installed, such as by not including a seal between the inlet and the outlet). The fluid distribution device 112 can receive fluid through the one or more pipes 108 and output the fluid according to a target spray pattern (e.g., by including a deflector that deflects the fluid according to the target spray pattern).

The sprinkler system 100 can include at least one valve 116. The valve 116 can be used to selectively control the flow of fluid from the fluid supply 104 to the at least one fluid distribution device 112. For example, the valve 116 can be changed from a closed state in which the valve 116 prevents fluid flow to a downstream side of the valve 116 from the fluid supply 104 to an open state in which the valve 116 allows fluid flow to the downstream side (e.g., to the fluid distribution device 112).

The valve 116 can be electrically controlled. For example, the valve 116 can include a solenoid that can cause the valve 116 to change from the closed state to the open state responsive to receiving an electrical signal (e.g., being electrified) or responsive to the electrical signal being discontinued (e.g., the solenoid being de-electrified).

The sprinkler system 100 can include a controller 120 that can provide the electrical signal to the valve 116 to control operation of the valve 116. The controller 120 can include a processor and memory. The processor may be implemented as a specific purpose processor, an application specific integrated circuit (ASIC), one or more field programmable gate arrays (FPGAs), a group of processing components, or other suitable electronic processing components. The memory can include one or more devices (e.g., RAM, ROM, flash memory, hard disk storage) for storing data and computer code for completing and facilitating the various user or client processes, layers, and modules. The memory can be or include volatile memory or non-volatile memory and may include database components, object code components, script components, or any other type of information structure for supporting the various activities and information structures of the inventive concepts disclosed herein. The memory can be communicably connected to the processor and include computer code or instruction modules for executing one or more processes described herein. The memory can include various circuits, software engines, and/or modules that cause the processor to execute the systems and methods described herein.

The controller 120 can be implemented by a fire control panel. The controller 120 can control operation of the valve 116 responsive to detecting a fire condition, such as to cause the valve 116 to change from the closed state to the open state responsive to detecting the fire condition. As discussed below, the controller 120 can include or be coupled with a detector 124 that detects the fire condition, responsive to which the controller 120 can cause the valve 116 to change from the closed state to the open state.

The sprinkler system 100 can include at least one detector 124. The detector 124 can monitor parameters in an environment around the fluid distribution device 112 to detect a trigger condition for triggering operation of the valve 116. The detector 124 can be included in or coupled with the controller 120, such that the controller 120 can control operation of the valve 116 responsive to detecting the fire condition based on receiving a detection signal from the detector 124 (or the detection signal itself can be used to trigger operation of the valve 116). The detector 124 can include a local power supply, such as a battery backup, to maintain operation in the event of a loss of power.

The detector 124 can include various detectors, such as temperature detectors, heat detectors, gas detectors, or smoke detectors. The detector 124 can detect a value of the parameter or a rate of change of the parameter, compare the value to a corresponding threshold, and output the detection signal responsive to the value satisfying a trigger condition, such as a minimum threshold. For example, the detector 124 can sense at least one of a temperature and a rate of change of temperature. The detector 124 can detect the fire condition responsive to at least one of the temperature meeting or exceeding a threshold temperature and the rate of change meeting or exceeding a threshold rate of change. The detector 124 can include multiple detectors (e.g., a temperature sensor and a gas concentration sensor), and determine the trigger condition to be satisfied responsive to a weighted evaluation of multiple parameters (e.g., comparing temperature to a temperature threshold and gas or smoke concentration to a gas or smoke concentration threshold).

The sprinkler system 100 can include at least one valve sensor 128. The valve sensor 128 can monitor a configuration of the valve 116 and cause an alarm responsive to the valve 116 not being in an operational state. For example, the valve sensor 128 can output an alarm signal responsive to the valve 116 not being in the operational state. The operational state of the valve 116 can include the coil of the solenoid being positioned on the core of the solenoid, such that the valve 116 can properly be caused to change from the closed state to the open state (e.g., while the valve 116 is in the operational state).

The valve sensor 128 can detect that the valve 116 is (or is not) in the operational state based on detecting (or not detecting) the coil of the solenoid while the valve sensor 128 is in a target position, and output a signal indicative of the valve 116 being (or not being) in the operational state. The valve sensor 128 can include a proximity sensor. For example, the valve sensor 128 can include a contact sensor, such as a switch, that is in a first state while in contact with the coil and a second state while not in contact with the coil, such that the valve sensor 128 can cause the alarm responsive to the contact sensor being in the second state. The valve sensor 128 can include an optical sensor that can detect the presence (or lack of presence) of the coil and cause the alarm responsive to not detecting the coil in proper position. The valve sensor 128 can include an electromagnetic sensor in which an induced current can change depending on the position of the coil, enabling the alarm to be triggered responsive to the position of the coil. The valve sensor 128 can include one or more of various contact or non-contact proximity sensors, including but not limited to radio frequency (e.g., infrared, microwave) sensors, sound-based sensors (e.g., ultrasonic sensor), capacitive sensors, or resistive sensors.

The sprinkler system 100 can include at least one sensor fastener 132. The sensor fastener 132 can secure the valve sensor 128 in a target position for detecting that the valve 116 is in the operational state. For example, the sensor fastener 132 can hold the valve sensor 128 in a position to be in contact with or aligned with a particular component of the valve 116.

The sprinkler system 100 can include at least one alarm 136. The at least one alarm 136 can be separate from the controller 120, or, as indicated by the dashed lines in the depiction of the controller 120 in FIG. 1, can be provided as part of the controller 120 (e.g., as part of a fire control panel that can implement the controller 120 and the alarm 136). The alarm 136 can output an indication of an alarm responsive to the valve sensor 128 detecting that the valve 116 is not in the operational state (e.g., based on receiving a signal from the valve sensor 128 that indicates that the valve 116 is not in the operational state, or based on discontinuation of a signal from the valve sensor 128 to indicate that the valve 116 is not in the operational state). For example, the alarm 136 can output at least one of an audio signal or a visual signal to indicate that the valve 116 is not in the operational state. The alarm 136 can transmit an alarm signal to a remote device (e.g., by wired or wireless transmission) to cause the remote device to output the at least one of the audio signal or the visual signal.

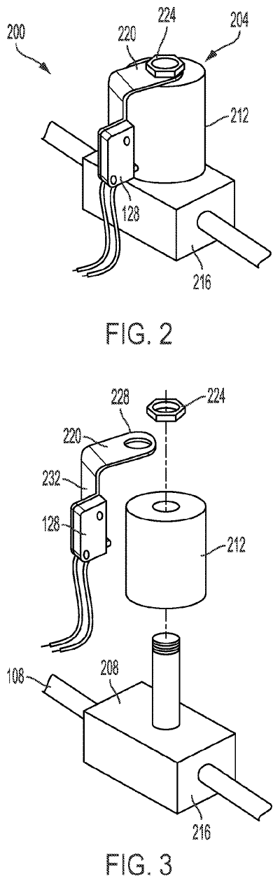

FIGS. 2-3 depict an example of a valve 200 in an assembled state (FIG. 2) and a disassembled state (FIG. 3). The valve 200 can incorporate features of the valve 116 described with reference to FIG. 1. The valve 200 can be implemented in a sprinkler system, such as the sprinkler system 100 described with reference to FIG. 1.

The valve 200 can include a solenoid 204. The solenoid 204 can include a core 208 and a coil 212 that can be positioned on the core 208. The core 208 can include a permanent magnet (e.g., iron), to facilitate operation of the solenoid 204. The coil 212 can be formed from a conductive wire (e.g., copper wire) that can be electrified by receiving an electrical current from a remote source (not shown).

The core 208 can be attached to a valve body 216. The valve body 216 can change from a closed state in which fluid is prevented from flowing through the valve body 216 to an open state in which fluid is allowed to flow through the valve body 216 (e.g., from the pipe 108 on an upstream side of the valve body 216 connected with the fluid supply 104 to a pipe 108 on a downstream side of the valve body 216 connected with the fluid distribution device 112). The valve body 216 can be changed from the closed state to the open state responsive to energizing (or de-energizing) of the solenoid 204. For example, the valve body 216 can be or include a member (e.g., plunger, armature) that can be driven by a magnetic field outputted by the energized solenoid 204.

The valve 200 can include the valve sensor 128. As depicted in FIGS. 2-3, the valve sensor 128 can be implemented using a contact sensor (e.g., a switch) based on contact with the coil 212. The valve sensor 128 can detect whether the coil 212 is positioned in order for the valve body 216 to be properly operated responsive to energizing (or de-energizing) of the solenoid 204. The valve sensor 128 can be positioned adjacent to at least one of the valve body 216 and a location in which the coil 212 is expected to be positioned in the operational state of the valve 200 (e.g., based on being attached with the bracket 220 and fastener 224 as described further below). For example, if the valve sensor 128 includes the contact sensor, the valve sensor 128 can detect that the coil 212 is properly positioned on the core 208 responsive to contact between the contact sensor and the coil 212 or the valve body 216 (such as if the coil 212 needs to be properly positioned on the core 208 in order for the valve sensor 128 to be in position to contact the valve body 216). As another example, if the valve sensor 128 includes a non-contact sensor, such as an optical sensor or electromagnetic sensor, the valve sensor 128 can detect that the coil 212 is properly positioned on the core 208 responsive to the valve sensor 128 being positioned in at least one of a target position and a target orientation relative to the coil 212 (e.g., the optical sensor can be used to detect a distance to the coil 212 and cause the alarm to be triggered responsive to the detected distance being more than a threshold amount different than an expected distance; the electromagnetic sensor can output an indication of an induced current caused by the coil 212 and cause the alarm to be triggered responsive to a magnitude of the induced current being more than a threshold amount different than an expected magnitude).

The valve 200 can include a bracket 220 and a fastener 224 (which can implement the sensor fastener 132 described with reference to FIG. 1). The bracket 220, while coupled with the coil 212 between the coil 212 and the fastener 224, can position the valve sensor 128 in a target position relative to at least one of the core 208 and the valve body 216 so that the valve sensor 128 can detect at least one of the coil 212 and the valve body 216. For example, if the valve 200 is properly assembled in the manner depicted in FIG. 2, the valve sensor 128 can be positioned in the target position and detect the at least one of the coil 212 and the valve body 216. If the valve 200 is not properly assembled, such as if the coil 212 is not replaced onto the core 208 after the valve 200 is serviced, the bracket 220 will not position the valve sensor 128 in the target position, responsive to which the valve sensor 128 can cause the alarm to be triggered (even if the coil 212 remains electrically connected with a source of electrical current to the coil 212). The fastener 224 can include various fastening elements, such as a nut as depicted in FIGS. 2 and 3, to secure the bracket 220 (and in turn the valve sensor 128) in position relative to the valve 200. The bracket 220 can extend from a first end 228 that can be positioned between the fastener 224 and the core 208 and a second end 232 that attaches with the valve sensor 128.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Computer program products are stored in a tangible form on non-transitory computer readable media and non-transitory physical hardware storage devices that are suitable for embodying computer program instructions and data. These include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory and other non-transitory devices.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced. Other substitutions, modifications, changes, and omissions may be made in the design, operating conditions and arrangement of embodiments without departing from the scope of the present disclosure.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A valve assembly, comprising:
a valve comprising:
a solenoid comprising a core and a coil; and
a valve body having a closed state in which fluid is prevented from flowing through the valve body and an open state in which fluid flows through the valve body; and
a valve sensor that detects at least one of the valve body and the coil and causes an alarm to be triggered responsive to not detecting the at least one of the valve body and the coil in a respective target position of the at least one of the valve body and the coil.

2. The valve assembly of claim 1, comprising:
a fastener that causes the valve sensor to be positioned in a sensor position at which the valve sensor is expected to detect the at least one of the valve body and the coil at the respective target position of the at least one of the valve body and the coil.

3. The valve assembly of claim 1, comprising:
a fastener that causes the valve sensor to be positioned in a sensor position at which the valve sensor is expected to detect the at least one of the valve body and the coil at the respective target position of the at least one of the valve body and the coil; and
a bracket comprising a first end that couples with the core between the fastener and the core and a second end that couples with the valve sensor.

4. The valve assembly of claim 1, comprising:
the valve sensor causes the alarm to be triggered responsive to not detecting the at least one of the valve body and the coil in a respective target position of the at least one of the valve body and the coil while the coil is receiving an electrical current.

5. The valve assembly of claim 1, comprising:
the valve sensor includes at least one of a switch, an optical sensor, an electromagnetic sensor, a radio frequency sensor, a capacitive sensor, a resistive sensor, and an ultrasonic sensor.

6. The valve assembly of claim 1, comprising:
the valve sensor causes the alarm to be triggered by at least one of outputting an electrical signal responsive to not detecting the at least one of the valve body and the coil at the respective target position of the at least one of the valve body and the coil and discontinuing output of the electrical signal responsive to not detecting the at least one of the valve body and the coil at the respective target position of the at least one of the valve body and the coil.

7. A sprinkler system, comprising:
one or more pipes that receive fluid from a fluid supply;
at least one fluid distribution device coupled with the one or more pipes;
a solenoid valve coupled with the one or more pipes between the fluid supply and the at least one fluid distribution device, the solenoid valve selectively allows fluid to flow from the fluid supply to the at least one fluid distribution device; and
a valve sensor that triggers an alarm responsive to detecting that the solenoid valve is not in an operational state.

8. The sprinkler system of claim 7, comprising:
an alarm that outputs an indication of an alarm condition responsive to the valve sensor triggering the alarm.

9. The sprinkler system of claim 7, comprising:
a fire detector that outputs a detection signal responsive to detecting a fire condition; and
a controller that causes the solenoid valve to change from a closed state to an open state responsive to the detection signal to allow the fluid from the fluid supply to flow to the at least one fluid distribution device.

10. The sprinkler system of claim 7, comprising:
a fire control panel that causes the solenoid valve to change from a closed state to an open state responsive to detecting a fire condition to allow the fluid from the fluid supply to flow to the at least one fluid distribution device, the fire control panel outputs an indication of an alarm condition responsive to the valve sensor triggering the alarm.

11. The sprinkler system of claim 7, comprising:
a fastener that causes the valve sensor to be positioned in a sensor position at which the valve sensor is expected to detect that the solenoid valve is not in the operational state.

12. The sprinkler system of claim 7, comprising:
the solenoid valve comprises a core and a coil that surrounds the core in the operational state.

13. The sprinkler system of claim 7, comprising:
a fastener that causes the valve sensor to be positioned in a sensor position at which the valve sensor is expected to detect that the solenoid valve is not in the operational state; and
a bracket comprising a first end that couples with the solenoid valve between the fastener and the solenoid valve and a second end that couples with the valve sensor.

14. The sprinkler system of claim 7, comprising:
the valve sensor causes the alarm to be triggered responsive to detecting that the solenoid valve is not in the operational state while the solenoid valve is receiving an electrical current.

15. The sprinkler system of claim 7, comprising:
the valve sensor includes at least one of a switch, an optical sensor, an electromagnetic sensor, a radio frequency sensor, a capacitive sensor, a resistive sensor, and an ultrasonic sensor.

16. The sprinkler system of claim 7, comprising:
the valve sensor causes the alarm to be triggered by at least one of outputting an electrical signal responsive to detecting that the solenoid valve is not in the operational state and discontinuing output of the electrical signal responsive to detecting that the solenoid valve is not in the operational state.

17. A valve sensor assembly, comprising:
a bracket extending from a first end that connects with a solenoid valve to a second end;
a fastener that secures the first end of the bracket with the solenoid valve; and
a sensor coupled with the second end of the bracket, the sensor indicates an alarm condition responsive to detecting that the solenoid valve is not in an operational state.

18. The valve sensor assembly of claim 17, comprising:
the valve sensor includes at least one of a switch, an optical sensor, an electromagnetic sensor, a radio frequency sensor, a capacitive sensor, a resistive sensor, and an ultrasonic sensor.

19. The valve sensor assembly of claim 17, comprising:
the sensor transmits an alarm signal to indicate the alarm condition responsive to detecting that the solenoid valve is not in an operational state.

20. The valve sensor assembly of claim 17, comprising:
the sensor detects that the solenoid valve is not in the operational state by detecting that a coil of the solenoid valve is not positioned on a core of the solenoid valve.
